(19) United States
(12) Patent Application Publication
(10) Pub. No.: US 2014/0239547 A1
(43) Pub. Date: Aug. 28, 2014

(54) The manner of production of container candle cartridges

(71) Applicants: Andrzej Wrobel, Wielun (PL); Jaroslaw Wolowiec, Wierzchlas (PL); Roman Kotala, Wielun (PL); Pawel Rzepka, Kowale (PL)

(72) Inventors: Andrzej Wrobel, Wielun (PL); Jaroslaw Wolowiec, Wierzchlas (PL); Roman Kotala, Wielun (PL); Pawel Rzepka, Kowale (PL)

(73) Assignee: KORONA SA, WIELUN (PL)

(21) Appl. No.: 14/236,873

(22) PCT Filed: Aug. 2, 2012
(86) PCT No.: PCT/PL2012/050025

§ 371 Date: May 1, 2014

(30) Foreign Application Priority Data
Aug. 2, 2011 (PL) 395836

(51) Int. Cl. C11C 5/00

(52) U.S. Cl. CPC C11C 5/008
USPC 264/268

(57) ABSTRACT

The manner of production of container candle cartridges which consists in the placement of a mould (1) surrounding the wick (2) in the container (3) together with the wick (2) and pouring the flammable mixture into the mould (1) and then its removal; it is also possible to leave the mould (1) if it is made from the flammable raw material and to fill the container (3) with the mixture. When using the mixture with the density range between 0.3 g/cm³ and 2.0 g/cm³, it is placed in the container (3) without a mould and it is applied by means of a forming element (5), and the mixture with the indicated density range out of which the cartridge (4) surrounding the wick (2) is formed solidifies at the moment of its application into the container (3) and it retains the shape sufficiently well in order to uphold the wick in the upright and centric position; then the container (3) with the formed cartridge (4) is poured over with the mixture.

The subject matter of the invention is the manner of production of container candle cartridges.

Until present the manufactured container candles had a cartridge surrounding the wick, the aim of which was to protect the wick from being covered with the flammable mass out of which the cartridge is built, the maintenance of wick centric position as well as the reduction of cooling time. The established methods of production of cartridge surrounding the wick used until now are based on the pressing process: first the liquid raw material is transformed into paraffin powder using tower or drum paraffin mills. Then the powder is formed into a cartridge with the wick, which is later placed manually or automatically in a candle container. After that the liquid raw material is poured into the prepared container with the inserted cartridge. Another popular method consists in casting the cartridge surrounding the wick: the raw material is poured into the prepared moulds and a cartridge with a wick is formed after it has set. After the cartridge has been removed from the mould, it is placed in the container and then it is covered with liquid raw material.

The disadvantage of such solutions is the need to use a complex infrastructure in the form of pressing and casting equipment, the equipment for the application of paraffin mouldings and energetically developed cooling systems, which are used together with the above equipment.

The invented procedure consists in heating up the raw material mixture of the candle cartridge and then cooling it down to the temperature slightly below the solidification point while stirring constantly, after which the prepared mixture is poured into the mould of the cartridge surrounding then wick together with the wick placed in the container; then the mould is removed and the container is filled with the mixture. It could be also advantageous to make the mould which is to be filled with the mixture from the flammable raw material and leave it in the container. It can also prove profitable to use the mixture with the density between 0.3 g/cm³ and 2.0 g/cm³, which is placed in the container without the mould and to bring the raw material mixture to the temperature slightly below the solidification point while stirring constantly. The mixture with the indicated density range which forms the cartridge surrounding the wick at the moment of its dispensing into the container shall solidify and shall retain its shape, which shall be sufficient for upholding the wick in the upright and centric position. The procedure described in the invention eliminates the processes of preparation and production of cartridge surrounding the wick and its placement in the container. It does not require the use of energy-intensive equipment, thanks to which it is possible to reduce production costs and to gain additional production space.

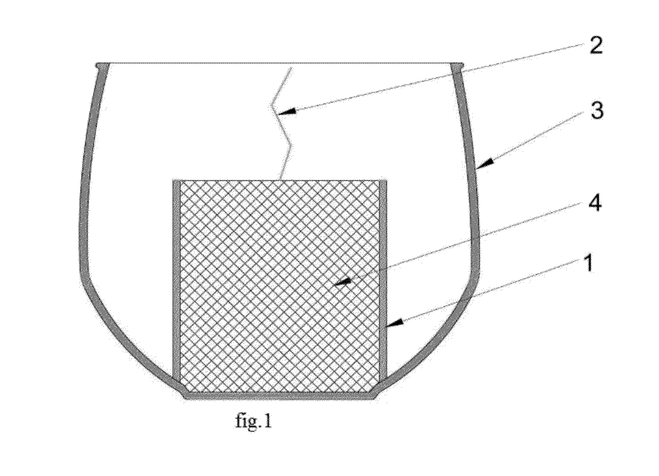

The candle produced according to the manner presented in the invention has been presented on the figures below: FIG. 1 shows the candle produced according to the first and the second manufacturing procedure and

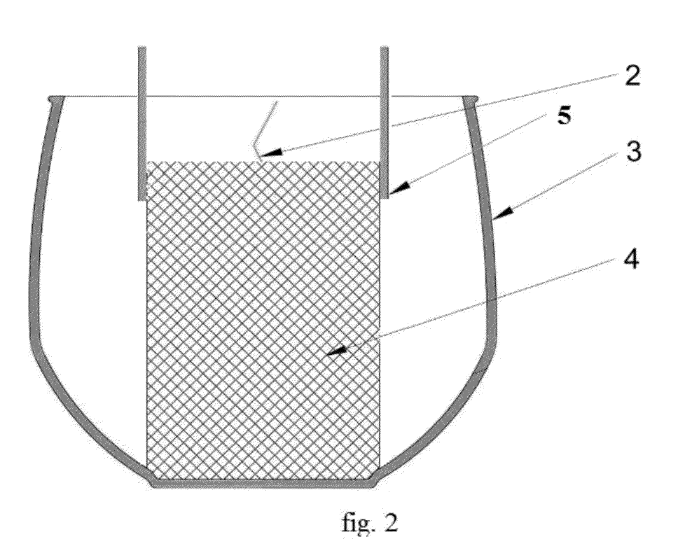

FIG. 2 shows the candle produced according to the third manufacturing procedure.

The 1^{st} Manufacturing Procedure:

The manner presented in the invention uses the mixture of flammable raw materials, which are heated up to the liquid state after which they combine, forming a uniform substance. Liquid mixture is cooled down while being stirred constantly. When it is cooled down to the temperature slightly below the solidification point it becomes semiliquid. Thus prepared mixture is poured into the mould of the cartridge surrounding the wick (1) together with the wick (2), previously placed in the container (3). Then the mould (1) is removed from the container (3) and the resulting cartridge (4) surrounding the wick (2) sets quickly, because it has been poured over with the mixture with the temperature close to the solidification point. The next activity consists in pouring the flammable mixture into the candle container (3).

The 2^{nd} Manufacturing Procedure:

The manner presented in the invention uses the mixture of flammable raw materials, which are heated up to the liquid state after which they combine, forming a uniform substance. Liquid mixture is cooled down while being stirred it constantly. When it is cooled down to the temperature slightly below the solidification point it becomes semiliquid. Thus prepared mixture is poured into the mould of the cartridge surrounding the wick (1) together with the wick (2), previously placed in the container (3). The mould (1) of the cartridge surrounding the wick (2) is produced from flammable material. The resulting cartridge (4) surrounding the wick (2) sets quickly, because it has been poured over with the mixture with the temperature close to the solidification point. The next activity consists in pouring the flammable mixture into the candle container (3).

The 3^{rd} Manufacturing Procedure:

The manner presented in the invention uses the mixture of flammable raw materials with the density between 0.3 g/cm³ and 2.0 g/cm³. Liquid mixture is cooled down to the temperature slightly below the solidification point while being stirred constantly. The mixture is placed in the container (3) without a mould; it is applied by means of a forming element (5) and it covers the wick (2). The mixture with the indicated density range out of which the cartridge (4) surrounding the wick (2) is formed at the moment of its application into the container (3) solidifies and it retains the shape sufficiently well in order to uphold the wick in the upright and centric position. The next activity consists in pouring the flammable mixture into the candle container (3).

1. The manner of production of container candle cartridges, which is distinguished by the fact that the raw material mixture out of which the container candle cartridge is produced is heated up then it is cooled down to the temperature slightly below the solidification point while stirring constantly, after which the resulting mixture is poured into the cartridge mould (1) together with the wick (2) placed in the container (3); then the mould (1) is removed from the container (3) and the container is filled with the mixture.

2. The manner as specified under claim 1, which is distinguished by the fact that the mould (1) is made from flammable material and is left in the container (3).

3. The manner of production of container candle cartridges, which is distinguished by the fact that the raw material mixture out of which the container candle cartridge is produced is heated up and then it is cooled down to the temperature slightly below the solidification point while being stirred constantly (the density of the used mixture ranges between 0.3 g/cm³ and 2.0 g/cm³); later it is applied to the container (3) without a mould by means of a forming element (5); the mixture with the indicated density range out of which the cartridge (4) surrounding the wick (2) is formed solidifies at the moment of its application into the container (3) and it retains the shape sufficiently well in order to uphold the wick in the upright and centric position; then the container (3) with the formed cartridge (4) is poured over with the mixture.
